(19) United States
(12) Patent Application Publication
(10) Pub. No.: US 2008/0249952 A1
(43) Pub. Date: Oct. 9, 2008

(54) COMPUTERIZED SYSTEM AND METHOD FOR MANAGING FINANCIAL INVESTMENT PORTFOLIOS

(76) Inventor: Henry BENTELER, St. Moritz (CH)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/695,800

(22) Filed: Apr. 3, 2007

(51) Int. Cl. G06Q 40/00

(52) U.S. Cl. 705/36 R

(57) ABSTRACT

For managing financial investment portfolios, one or more underlying investment selections are received (S11) on a computerized server from a user for his portfolio. The portfolios each include investment positions related to stocks, options and/or futures contracts, and associated with one or more broker accounts. Current financial market analysis data (18) is determined (S22) for the underlying investment selections of a portfolio, based on historical and current financial market data. Based on the current financial market analysis data (18), generated (S14) for a portfolio is order data relating to orders for decreasing existing investment positions, for increasing existing investment positions, and/or for establishing new investment positions. The order data indicates for each order a selected one of the underlying investment selections, an investment instrument related to stocks, options or futures contracts for the selected one of the underlying investment selections, as well as an order quantity, an order price, and a broker account. Thus, generated automatically and dynamically for a user are portfolio-specific investment orders based on the current portfolio structure and current financial market analysis data (18).

### FIELD OF THE INVENTION

The present invention relates to a computerized system and a computer-implemented method for managing financial investment portfolios. Specifically, the present invention relates to a computerized system and a computer-implemented method for managing financial investment portfolios whereby each portfolio includes multiple investment positions which are related to stocks, options and/or futures contracts, and which are associated with one or more broker accounts.

### BACKGROUND OF THE INVENTION

Conventionally, automated trading programs assist users in investing in a specific investment title. Furthermore, conventional trading programs typically place investments in a single investment instrument, e.g. a stock, an option or a futures contract. However, investing independently in a few selected titles bears a significant risk as the financial exposure is too focused. Particularly, non-professional investors who are not experienced in risk management, analysis tools, money management, market assessment, and financial portfolio theory, tend to invest exclusively in long positions and hold significant parts of their capital resources, e.g. more than 15%, in one single title. On one hand, such investors often need to give up investment positions, because of a lack of sufficient financial resources, while, on the other hand, they keep positions even though the market moves clearly in a disadvantageous direction for that position. Frequently, such inexperienced investors keep investing in the market, although they have already lost more than 10% of their capital resources, for example. Professional and experienced investors observe the markets extensively and use a variety of analysis tools, when managing an investment portfolio. Nevertheless, also experienced investors can get surprised, e.g. by sudden movements of the market and/or an unexpected increase of client money to be invested, to the effect that it becomes very difficult, if not impossible, to maintain a thorough and analytical approach when making investment decisions. Consequently, it would be useful for inexperienced as well as experienced investors to have an automated tool that provides consistent and emotionless assistance for managing financial investment portfolios.

### SUMMARY OF THE INVENTION

It is an object of this invention to provide a computerized system and a computer-implemented method for managing financial investment portfolios, each comprising multiple investment positions related to stocks, options and/or futures contracts for various underlying investment selections (“underlying”). In particular, it is an object of the present invention to provide a computerized system and a computer-implemented method for generating orders for investment positions of a financial investment portfolio, each investment position relating to a stock, an option or a futures contract.

According to the present invention, these objects are achieved particularly through the features of the independent claims. In addition, further advantageous embodiments follow from the dependent claims and the description.

According to the present invention, the above-mentioned objects are particularly achieved in that, for managing financial investment portfolios, each portfolio including a user's multiple investment positions related to stocks, options and/or futures contracts, and associated with one or more broker accounts, one or more underlying investment selections are received from the user for his portfolio. For example, an underlying investment selection relates to a specific commodity, e.g. gold or wheat, or a specific company with publicly traded stocks, e.g. UBS or IBM. For the underlying investment selections of a portfolio, current financial market analysis data is determined based on historical and current financial market data. Preferably, the current financial market analysis data includes dynamic indicators representative of observed dynamic changes of the underlying investment selections. Subsequently, for a specific portfolio, based on the current financial market analysis data, generated is order data relating to orders for decreasing existing investment positions, for increasing existing investment positions and/or for establishing new investment positions. Decreasing existing investment positions may include liquidation of existing investment positions. The order data indicates for each order a selected one of the underlying investment selections associated with the specific portfolio, an investment instrument related to a stock, an option or a futures contract for the selected one of the underlying investment selections, as well as an order quantity, an order price, and a broker account. The generated order data is communicated to the respective user. In the examples mentioned above, an order relates to an investment instrument such as an option for gold, a futures contract for wheat, a UBS stock, or an option on an IBM stock, for example. Preferably, the underlying investment selections are received from the user via a telecommunications network, e.g. through a user interface provided on a server, and the order data is provided to the user via the telecommunications network, e.g. by the server via the Internet.

The proposed system and method for managing financial investment portfolios make it possible to generate portfolio-specific investment orders based on the current portfolio structure and current financial market analysis data. The portfolio structure is defined by portfolio structure data indicating the investment positions included in a user's portfolio, each investment position relating to a stock, an option or a futures contract for one of the underlying investment selections, and being associated with one or more broker accounts. For defining a user's portfolio structure, received from the user is portfolio structure data representative of the current structure of the user's portfolio. Alternatively, for maintaining automatically an updated portfolio structure, received from the user is order placement data indicative of orders placed by the user based on previous order data, for example. Preferably, for the underlying investment selections of a portfolio, the financial market analysis data is updated automatically, dynamically and repeatedly more than once a day, e.g. periodically and as frequently as every five to fifteen minutes during office hours, for example, based on historical and current financial market data. Thus, updated order data is generated dynamically and automatically for the user's portfolio based on the current portfolio structure and based on the updated financial market analysis data.

In a preferred embodiment, for maintaining capital resources associated with an existing investment position related to a specific underlying investment selection in a user's portfolio, the market exposure of the user's portfolio is decreased by generating order data for an order relating to an investment position mirroring at least partially the existing investment position. An existing long investment position is mirrored by a corresponding short investment position, whereas an existing short investment position is mirrored by a corresponding long investment position. For cases where existing investment positions related to a specific underlying investment selection are spread across different broker accounts associated with a portfolio, the order for the mirroring investment position is generated such that the existing investment position is mirrored at least (partly) for one of the accounts.

By mirroring investment positions in a portfolio, the market exposure of the portfolio is reduced. Thus, an order generated for mirroring an existing investment position is a decrease order, as it decreases the market exposure of a portfolio. Moreover, mirroring investment positions (defensively) makes it possible to avoid realizing losses and to react more flexibly in contradicting market situations. Should the financial market analysis data have indicated the market development for the specific underlying investment selection too negatively, and should thus a respective long investment position have been mirrored unnecessarily, the upside potential of the long investment position, for example, is still maintained, so that the mirrored investment position can generally be disposed of without (significant) losses at a point in time selected by the user, rather than at a point in time forced upon the user by market dynamics or portfolio situation. On the other hand, if the market development shows that mirroring the investment position was justified, the loss of the long investment position can be compensated by the profit from the short investment position. Typically, the negative trend will change sooner or later. At that time, orders are generated for realizing the profit from the mirroring investment position (e.g. short) and, market and portfolio analysis permitting, for increasing the mirrored investment position (e.g. long). Mirroring investment positions aggressively, on the other hand, makes it possible to realize temporary, passing profit opportunities that otherwise would only be possible with a permanent observation of the portfolio.

In a further preferred embodiment, orders for a specific portfolio are generated such that, for any broker account of the specific portfolio, a maximum portion of capital resources associated with the broker account is invested. Maximizing the invested portion of the capital resources, for example as close to 100% of the capital as possible, makes it possible to significantly increase the overall revenue prospective.

In a further preferred embodiment, suppressed are orders for increasing existing investment positions related to a specific underlying investment selection of a portfolio, as long as there are pending orders for decreasing existing investment positions related to the specific underlying investment selection of the portfolio. Thus, as a first priority, orders are always generated, in particular, to maintain the capital resources associated with an existing investment position and, in general, to maintain the capital resources associated with a portfolio. As long as there are still protective orders in effect for any particular underlying investment selection, no orders will be generated that might increase the portfolio's market exposure in that underlying investment selection.

In a further embodiment, stopped is the generation of orders for increasing existing investment positions and/or for establishing new investment positions in cases where a loss portion of capital resources associated with the user's portfolio exceeds a defined loss limit, or where the number of underlying investment selections having a net loss exceeds a defined loss position limit. For example, no increase orders are generated when more than eight percent of the portfolio's capital resources are in a loss position, or when there are more than nine underlying investment selections showing a net loss.

Preferably, the market exposure of a user's portfolio is decreased by generating order data, for orders relating to investment positions mirroring existing investment positions and/or for decreasing existing investment positions while realizing a loss, for the case where an invested portion of capital resources associated with the user's portfolio exceeds a defined investment limit and the current financial market analysis data is indicative of an alternative investment opportunity for the portfolio's underlying investment selections, e.g. if the current financial market analysis data shows an uptrend for one or more of the underlying investment selections.

It is another object of the present invention to provide a computerized system and a computer-implemented method for generating orders for investment positions of a financial investment portfolio, each investment position relating to a stock, an option or a future, and being associated with one or more broker accounts. Received from the user are one or more underlying investment selections for the portfolio. For the underlying investment selections, current financial market analysis data is determined, based on historical and current financial market data. Based on the current financial market analysis data, generated for the portfolio are order data relating to orders for decreasing existing investment positions, for increasing existing investment positions and/or for establishing new investment positions, the order data indicating for each order a selected one of the underlying investment selections, an investment instrument related to a stock, an option or a futures contract for the selected one of the underlying investment selections, as well as an order quantity, an order price, and a broker account.

It is yet another object of the present invention to provide a computerized system and a computer-implemented method for managing financial investment portfolios, whereby received from a user is portfolio structure data related to the user's financial investment portfolio. The portfolio structure data indicates financial investment positions included in the portfolio. Each investment position is related to a stock, an option or a futures contract for an underlying investment selection, and associated with one or more broker accounts. For the underlying investment selections, determined are current financial market analysis data based on historical and current financial market data. Based on the current financial market analysis data and the portfolio structure data, generated for the portfolio are order data relating to orders for decreasing existing investment positions, for increasing existing investment positions and/or for establishing new investment positions. The order data indicates for each order a selected one of the underlying investment selections, an investment instrument related to a stock, an option or a futures contract for the selected one of the underlying investment selections, as well as an order quantity, an order price, and a broker account.

In addition to a computerized system and a computer-implemented method for managing financial investment portfolios, and a computerized system and a computer-implemented method for generating orders for investment positions of a financial investment portfolio, the present invention also relates to respective computer program products including computer program code means for controlling one or more processors of a computerized server, particularly, computer program products including a computer readable medium containing therein the computer program code means. The program code means are configured for controlling the processor(s) such that the server executes the method of managing the financial investment portfolios or the method of generating orders for the investment positions of the financial investment portfolio, respectively.

### BRIEF DESCRIPTION OF THE DRAWINGS

The present invention will be explained in more detail, by way of example, with reference to the drawings in which:

FIG. 1 shows a block diagram illustrating schematically an exemplary configuration of a computerized system for practicing embodiments of the present invention, said configuration comprising a computerized server accessible for users with communication terminals via a telecommunications network.

FIG. 2 shows a flow diagram illustrating an example of a sequence of steps executed according to the present invention for managing financial investment portfolios and generating orders for investment positions of financial investment portfolios.

FIG. 3 shows a flow diagram illustrating an example of a sequence of steps executed according to the present invention for generating order data for investment positions of financial investment portfolios.

FIG. 4 shows a flow diagram illustrating a further example of a sequence of steps executed according to the present invention for generating the order data.

### DETAILED DESCRIPTION OF THE PREFERRED EMBODIMENTS

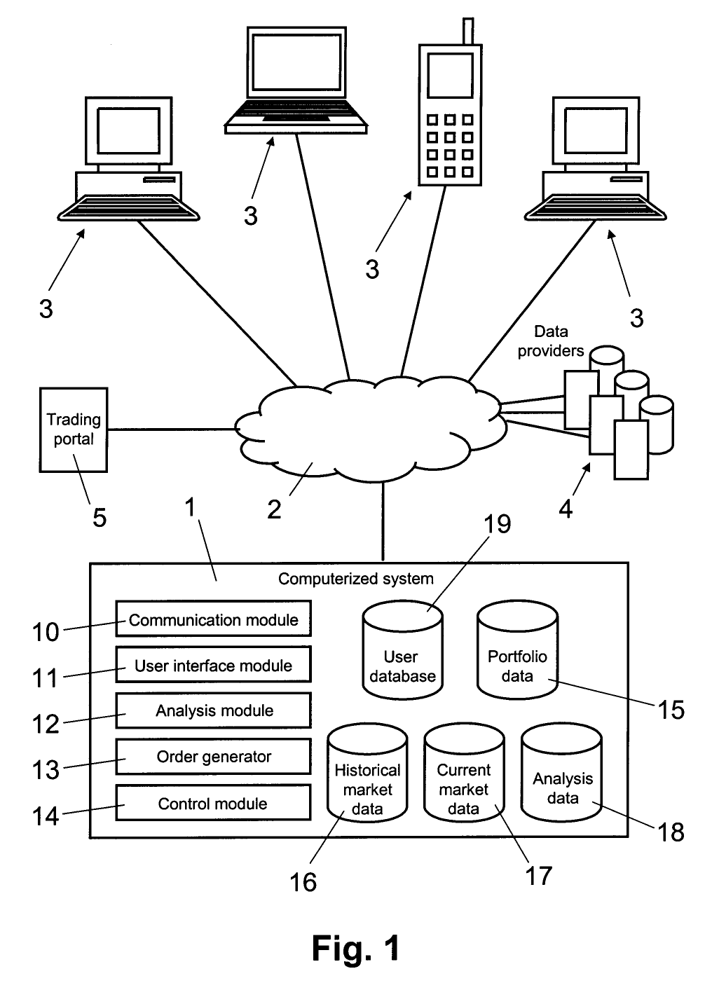

In FIG. 1, reference numeral 1 refers to a computerized system for managing financial investment portfolios and for generating orders for investment positions of the financial investment portfolios. The system 1 includes one or more computers, for example computerized servers, comprising one or more processors. As is illustrated, the system 1 is connected via a telecommunications network 2 to multiple communication terminals 3.

The telecommunication network 2 includes fixed networks and/or wireless networks. For example, the telecommunication network 2 includes a local area network (LAN), an integrated services digital network (ISDN), the Internet, a global system for mobile communication (GSM), a universal mobile telephone system (UMTS) or another mobile radio telephone system, and/or a wireless local area network (WLAN).

The communication terminals 3 are implemented as personal computers, laptop computers, mobile radio telephones and/or personal digital assistants, for example.

The system 1 includes a communication module 10 for exchanging data with the communication terminals 3 via the telecommunications network 2. Access to system 1 from communication terminals 3 is controlled, for example through a login requiring user identification and password.

As is illustrated schematically in FIG. 1, the system 1 further includes various functional modules and data stores, in the form of a database, a data file and/or a spreadsheet, for example.

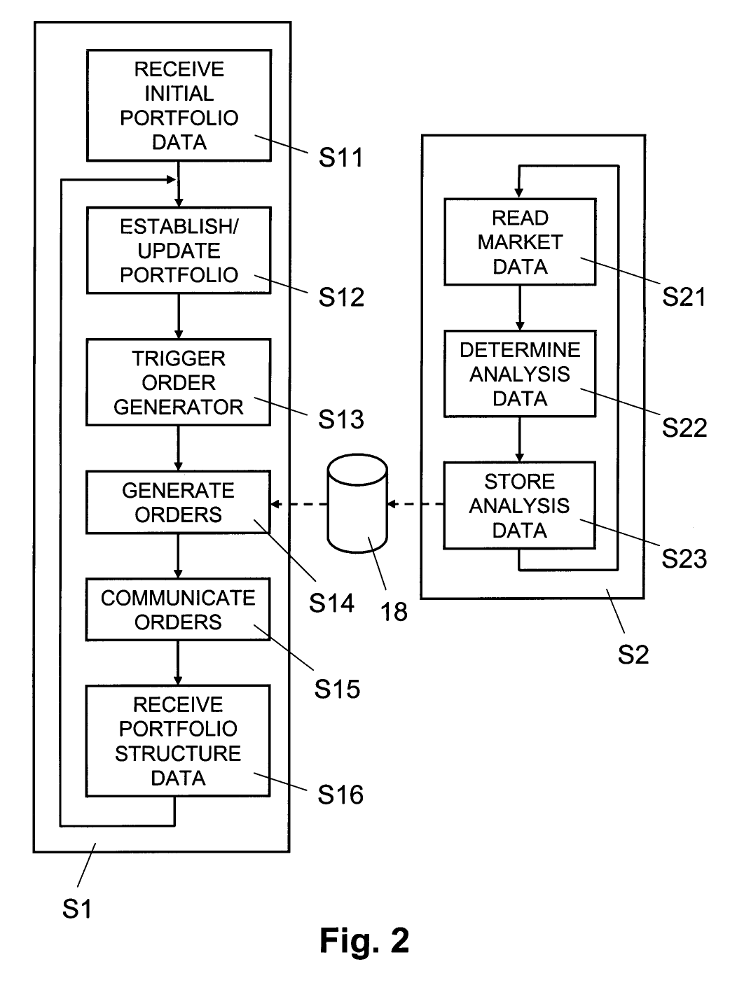

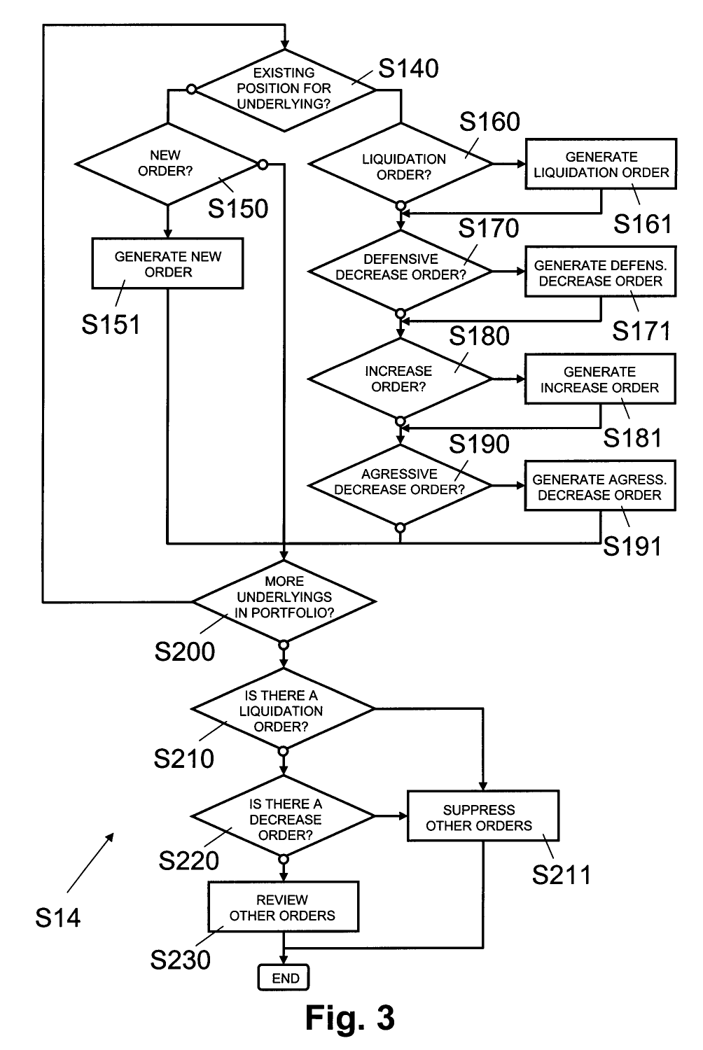

The functional modules include a user interface module 11, an analysis module 12, an order generator 13, and a control module 14. Preferably, the functional modules are implemented as programmed software modules. The computer program code of the software modules is stored in a computer program product, i.e. in a computer readable medium, either in memory integrated in a computer of the system 1 or on a data carrier that can be inserted into a computer of the system 1. The computer program code of the software modules controls the computer(s) of the system 1 so that the system 1 executes various functions described later in more detail with reference to FIGS. 2 and 3.

The data stores include a user database 19 for a plurality of subscribed users, a data store for financial investment portfolios 15, a data store for historical financial market data 16, a data store for current financial market data 17, and a data store for current financial market analysis data 18.

The financial investment portfolios 15 are each associated with one of the users stored in the user database 19. A user's financial investment portfolio 15 includes the user's underlying investment selections, often simply referred to as “underlying”. Furthermore, a financial investment portfolio 15 includes information about multiple investment positions, each related to stocks, options or futures contracts associated with one of the user's underlying investment selections. Each investment position is associated with a broker account; individual broker accounts may be associated with different brokers. For example, the system 1 supports five different accounts per portfolio, the accounts being associated with the same or with different brokers (typically, the brokers' identities are not known by the system but defined by a reference number). Furthermore, a financial investment portfolio 15 may include one or more accounts related to cash (leverage) and/or bonds. The total value of cash, bonds and investment positions included in the account(s) of a financial investment portfolio 15 constitutes the user's capital resource associated with the respective financial investment portfolio 15. In addition, a financial investment portfolio 15 is associated with user preferences such as an assignment of underlying investment selections to preferred broker accounts, indicating that the preferred broker accounts are to be used for purchasing investment instruments for these underlying investment selections. Furthermore, the user preferences include a user-defined broker limit, specifying a limit for the portion of capital resources that may be invested at one specific broker (e.g. 40%), a user-defined currency exposure limit, specifying a limit for the portion of capital resources that may be invested in a specific currency (e.g. 25%), or a user-defined index exposure limit, specifying a limit for the portion of capital resources that may be invested in investment instruments associated with a specific index (e.g. 20%).

As is illustrated schematically in FIG. 1, at least one computerized broker portal 5 as well as various computerized data providers 4 are connected to the telecommunications network 2. However, there is no connection between the broker portal 5 and the system 1, unless optional services for automatic placement of orders are implemented.

The analysis module 12 is configured to access the computerized data providers 4 and read historical and current financial market data provided by the computerized data providers 4. Furthermore, the analysis module 12 is configured to execute step S2, as shown in FIG. 2, for determining current financial market analysis data.

As is illustrated in FIG. 2, in step S21, the analysis module 12 reads historical and current financial market data provided by the computerized data providers 4 and updates the local data stores for current financial market data 17 and the local data store for historical financial market data 16. It is also possible that only the local data store for current financial market data 17 is updated with current financial market data from the computerized data providers 4. The financial market information is updated repeatedly, e.g. periodically every five to fifteen minutes, or triggered by the needs of the order generator 13, or as requested by a user of the system. Preferably, the financial market information is updated for all portfolios maintained by the system 1. In an alternative embodiment, the financial market information is updated exclusively for the underlying investment selections included in the financial investment portfolios 15, either for all portfolios maintained by the system 1 or, selectively, as needed by the order generator 13 for managing a specific one of the portfolios.

In step S22, the analysis module 12 determines current financial market analysis data based on the historical and current financial market data 16, 17. Preferably, the current financial market analysis data is determined for all portfolios maintained by the system 1. In an alternative embodiment, the current financial market analysis data is determined exclusively for the underlying investment selections included in the financial investment portfolios 15, either for all portfolios maintained by the system 1 or, selectively, as needed by the order generator 13 for managing a specific one of the portfolios. For each of the relevant underlying investment selections, the current financial market analysis data includes dynamic indicators and expected upper and lower price limits. The dynamic indicators reflect observed changes in the price of the underlying investment selection over defined time periods. Specifically, the dynamic indicators indicate price changes with respect to the lowest/highest value of the last x number of days. For example, the dynamic indicators for the period of the last ten days include DYN_{10low}=(LQ−Low[n . . . n-10])/10*LQ and DYN_{10high}=(High[n . . . n-10]−LQ)/10*LQ, LQ being the value of the last quote, Low[n . . . n-10] and High[n . . . n-10] being the lowest or highest value, respectively, of the trading days n to n-1, n being the latest closed trading day. For different purposes, the current financial market analysis data include dynamic indicators for different lengths of time periods, e.g. DYN₁₀, DYN₅₀ and DYN₁₀₀, as well as combinations thereof, e.g. (DYN₁₀+DYN₅₀)/2. The expected price range (upper and lower price limits) are determined based on the closing value of the previous trading day by calculating average differences (distances) to the High and Low values of the next trading day. In an embodiment, the expected upper and lower price limits are adapted depending on dynamics and market conditions. If the last quote is outside of the expected price range, the expected price range is shifted accordingly. Typically, the order price is indicated as a percentage of the expected price range, e.g. purchase investment instrument xyz at 20% or below.

In step S23, the analysis module 12 stores the data determined in step S22 in the data store configured for current financial market analysis data 18, assigning underlying-specific data to the respective underlying investment selection.

Using the communication module 10, the order generator 13 is configured to communicate with authorized users of communication terminals 3 through user interface module 11 via telecommunications network 2. The user interface module 11 may be implemented as a conventional web page, e.g. in HTML, or as an applet, e.g. a Java applet, and accessed from the communication terminals 3 through conventional web browser applications such as Microsoft's Explorer, Apple's Safari or Mozilla Firefox. One skilled in the art will understand, however, that the user interface module 11 may be implemented in alternative ways, e.g. as a graphical user interface of an application run on a computer of system 1 or on the communications terminals 3. Access to the user interface 11 and to the system 1 is limited in conventional ways to authorized users only.

In FIG. 2, step S1 refers to a collection of steps S11 to S16 performed for managing financial investment portfolios and for generating orders for investment positions of the financial investment portfolios.

In step S11, the user interface module 11 receives from the user initial portfolio structure data. The initial portfolio structure data indicates one or more broker accounts. Each of the broker accounts is associated with existing investment positions and/or cash. If a user holds bonds in one or more of his accounts, the liquidation value of these bonds can be included in the user's cash value. Management of bonds is possible in the form of options and futures contracts for bonds.

Each of the investment positions is related to stocks, options or futures contracts for an underlying investment selection. The initial portfolio structure data may also indicate further underlying investment selections for which there are not yet any existing investment positions. The initial portfolio structure data is captured by the user interface module 11 as a data file specified and/or provided by the user, or as individual data entries provided by the user, for example. In addition, the user interface module 11 receives user preferences from the user as outlined above.

In step S12, the control module 14 establishes and updates the user's portfolio in the local data store for financial investment portfolios 15.

In step S13, the control module 14 triggers the order generator 13, for example, in response to a user request from one of the communication terminals 3, or in response to updated financial market analysis data 18 from analysis module 12. Upon being triggered, the order generator 13 generates orders for the user's specific investment portfolio or for all the financial investment portfolios 15 stored in the system 1, respectively. Preferably, up-to-date (current) orders are generated repeatedly, e.g. periodically and as frequently as every five to fifteen minutes, whenever there are newly updated financial market analysis data 18.

In step S14, based on the current financial market analysis data 18 and the updated (current) portfolio structure(s), the order generator 13 generates new orders for decreasing/liquidating existing investment positions, for increasing existing investment positions and/or for establishing new investment positions. As shown in Table 1, each order comprises an identifier that defines a specific investment instrument for one of the underlying investment selections (“underlying”) associated with the respective portfolio, including available options and futures contracts.

TABLE 1

| | | | |
|---|---|---|---|
| Identifier of investment | Order | Order price | Broker |
| instrument for an underlying | quantity | | account |

| | |
|---|---|
| Underlying | Investment |
| investment | instrument |
| selection | (stock, option, |
| | future) |

Each investment instrument is either a specific stock traded at a specific stock exchange, an option, or a futures contract. Each order also includes an order quantity, specifying the number of units of the respective investment instrument to be ordered, an order price, specifying the price for which the respective investment instrument is to be ordered, and a broker account for which the specified quantity of the respective investment instrument is to be ordered. In the case of options and futures contracts, the order also includes strike price and execution date. One skilled in the art will understand that the broker account may not have to be indicated in an order, if there is only one broker account associated with a portfolio. The order price is preferably indicated as a specific price with an absolute value. Alternatively, the order price could be indicated as a range with an upper and lower price limit, or as a maximum upper or lower price.

FIG. 3 illustrates schematically the basic logic for generating orders in step S14.

In step S140, the order generator 13 checks whether there is no existing position of an underlying investment selection.

If there are no existing positions, in step S150, the order generator 13 determines, based on the current financial market analysis data 18 and the current portfolio structure, whether it is possible to establish new investment positions for the respective underlying investment selection. Orders for establishing new investment positions are prevented (suppressed), for example, if the invested portion of capital resources associated with the user's portfolio exceeds a (user) defined investment limit, if a portion of the capital invested at a specific broker exceeds the user-defined broker limit, if a portion of the capital invested in a specific currency exceeds the user-defined currency exposure limit, and/or if a portion of the capital invested in a specific index exceeds the user-defined index exposure limit. Further criteria for generating orders for new positions are described below in the context of steps S144 to S146. If it is possible to establish new investment positions, the order generator 13 continues in step S151, otherwise in step S200.

In step S151, the order generator 13 generates an order for establishing new investment positions for the respective underlying investment selection (order type “NEW” or “NEW urgent”, if the respective dynamic indicators exceed a dynamics threshold value, for example).

If there are existing positions of the respective underlying investment selection, in step S160, the order generator 13 determines, based on the current financial market analysis data 18 and the current portfolio structure, whether there is a requirement to decrease the market exposure by liquidating existing investment positions for the respective underlying investment selection. For example, existing investment positions are liquidated if (with respect to long positions) the dynamics of the positions do not meet a predefined criteria (e.g. DYN*POS>0.5%), or the expected return rate is not higher than a defined minimum return rate (e.g. risk return rate>10%), or the acquisition price is not below an experienced price development (e.g. acquisition price<the highest value in the last three trading days).

If there is a need to liquidate existing investment positions, in step S161, the order generator 13 generates an order for liquidating at least part of the respective investment positions (order type “LIQ”).

If there is no need to liquidate existing investment positions of the respective underlying investment selection, in step S170, the order generator 13 determines, based on the current financial market analysis data 18 and the current portfolio structure, whether there is a requirement to decrease the market exposure by decreasing defensively the respective investment positions. Criteria for decreasing defensively the market exposure are described below in the context of steps S141 to S143.

If there is a need to decrease defensively existing investment positions, in step S171, the order generator 13 generates an order for decreasing at least part of the respective investment positions (order type “DECR defensive”). Decreasing investment positions defensively includes defensive mirroring of at least a part of the respective investment position. Specifically, based on the required portion of a position to be mirrored (maximum 100% of the market exposure of the respective position), the decrease order is assigned to the account of the portfolio that permits the placement and results in the least amount of unused capital resources associated with the user's portfolio.

If there is no need to decrease the market exposure, in steps S180 or S190, respectively, the order generator 13 determines, based on the current financial market analysis data 18 and the current portfolio structure, whether it is possible to increase or decrease aggressively the existing investment positions for the respective underlying investment selection.

The order generator 13 does not generate increase orders, if a loss portion of capital resources associated with the portfolio exceeds a defined loss limit, e.g. if a portion of more than 8% of the capital resources is lost, according to the current market situation; and/or if the number of investment positions in a loss position exceeds a loss position limit. Moreover, orders for increasing existing investment positions are prevented (suppressed), for example, if the invested portion of capital resources associated with the user's portfolio exceeds a (user) defined investment limit, if a portion of the capital invested at a specific broker exceeds the user-defined broker limit, if a portion of the capital invested in a specific currency exceeds the user-defined currency exposure limit, and/or if a portion of the capital invested in a specific index exceeds the user-defined index exposure limit. Further criteria for generating increase orders are described below in the context of steps S144 to S146.

The last quote or the desired order price, respectively, is indicated as a percentage value with respect to the expected price range, the lower price limit corresponding to 0%, and the upper price limit corresponding to 100%. Thus, the defined investment rules may prescribe a threshold value for the last quote, e.g. 75%; above this threshold value, existing investment positions are decreased aggressively (aggressive mirroring). Further general criteria for generating orders are described below in the context of steps S141 to S146.

If it is possible, to increase or decrease aggressively the respective investment position, in steps S181 or S191, respectively, the order generator 13 generates an order for increasing investment positions for the respective underlying investment selection (order type “INCR” or “INCR urgent”, if the respective dynamic indicators exceed a dynamics threshold value, for example), or an order for decreasing aggressively the investment positions (order type “DECR aggressive”). Decreasing investment positions aggressively includes aggressive mirroring of at least a part of the respective investment position.

In step S200, the order generator 13 checks whether there are more underlying investment selections to be processed for the portfolio. If the portfolio contains further underlying investment selections to be processed, the order generator 13 continues in step S140, otherwise in step S210.

In step S210, the order generator 13 determines whether any orders for liquidating investment positions had been generated for the portfolio. For liquidating orders, the order price is set to the current market price.

If there are liquidation orders, in step S211, the order generator 13 suppresses any other orders for the portfolio.

Otherwise, if there are no liquidation orders, in step S220, the order generator 13 determines whether any orders for defensive decrease of investment positions had been generated for the portfolio.

If there are defensive decrease orders, in step S211, the order generator 13 suppresses any other orders for the portfolio.

Otherwise, if there are no defensive decrease orders, in step S230, the order generator 13 reviews the orders generated for establishing new investment positions, for increasing existing investment positions, and/or for decreasing aggressively existing investment positions as to whether or not they are to be included in a communication of orders to the respective user. For example, if the desired order price is more than a defined maximum difference (e.g. 2%) off the last quoted market price, the respective order for establishing new investment positions or increasing existing investment positions are suppressed and not communicated to the user. This applies to all orders, because it is typically not sensible to pass orders to a broker, if the order price is too aggressive, e.g. if the order price differs by more than 3% from the last quoted market price.

Generally, the basic logic for generating orders in step S14 ensures as a first priority that orders are generated to maintain the capital resources associated with individual investment positions of a portfolio and with the portfolio as a whole.

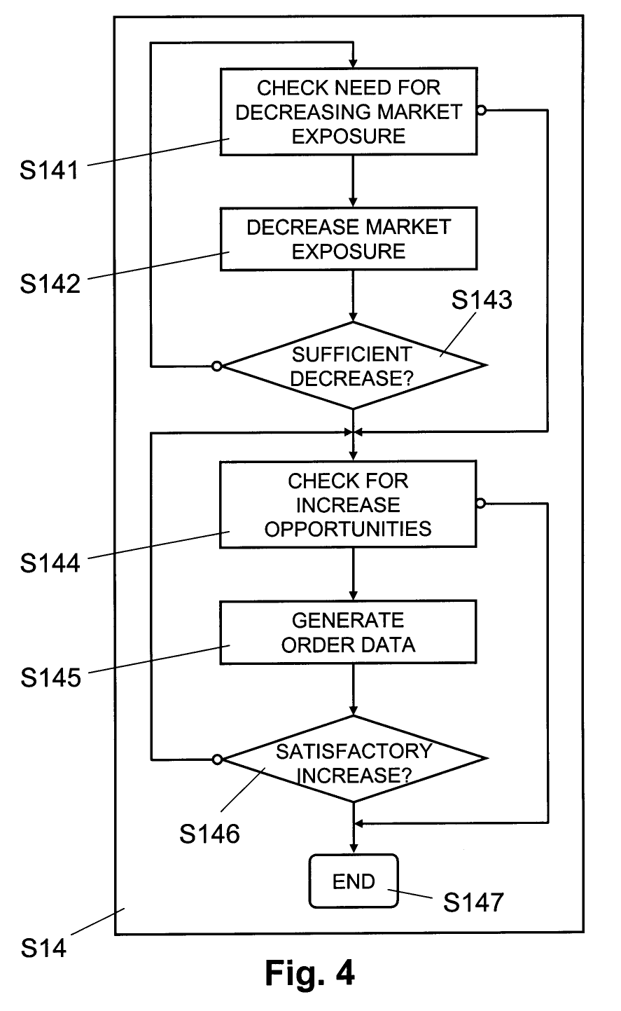

FIG. 4 illustrates an example of processing step S14 with alternative sequencing of steps.

In step S141, based on the current financial market analysis data 18, the order generator 13 checks the current portfolio structure for the need to decrease the market exposure of individual investment positions included in the portfolio. The market exposure of one or more investment positions may be decreased, if the invested portion of the capital resources associated with the portfolio exceeds a system- or user-defined investment limit, e.g. 95%, and/or if the current financial market analysis data or the updated portfolio structure is in violation of system-defined safety rules for maintaining the capital resources associated with the user's portfolio. Such safety rules apply, for example, if the number of underlying investment selections having a net loss exceeds a defined loss position limit (e.g. nine), if the loss portion of capital resources associated with the user's portfolio exceeds a defined loss limit, e.g. defined as a percentage of the capital, and/or if the liquidation value of an underlying investment selection exceeds a defined underlying limit, e.g. defined as a percentage of the capital.

Moreover, the market exposure of a specific investment position is decreased, if the current financial market analysis data indicates, according to defined investment rules, that the respective underlying investment selection is no longer expected to be an interesting investment option. For example, the defined investment rules may prescribe a minimum degree of (positive or negative) dynamics in the price development within a defined period of time.

If there is no need to decrease the market exposure, the order generator 13 continues in step S144.

In step S142, the order generator 13 generates decrease orders for decreasing the market exposure of the portfolio based on the results of step S141. If a decrease of an investment position were to result in a loss, the market exposure of the investment position is primarily reduced through mirroring the position to avoid realization of a loss. For mirroring an existing long investment position, an order is generated for a corresponding short investment position. For mirroring an existing short investment position, an order is generated for a corresponding long investment position. If the investment position to be mirrored is distributed across multiple broker accounts, the order generator 13 generates first an order to mirror the positions on the broker account with the largest quantity of the position. Investment positions are only decreased with a loss if the invested portion of the capital resources associated with the user's portfolio exceeds a defined investment limit and the current financial market analysis data is indicative of an alternative investment opportunity for the portfolio's underlying investment selections.

In step S143, the order generator 13 uses a money management function to determine whether the market exposure of the portfolio has been sufficiently decreased to meet any system- and/or user-defined limits. If a satisfactory reduction of the portfolio's market exposure has been reached, the order generator 13 continues in step S144; otherwise, the order generator 13 returns to step S141, to determine further opportunities for decreasing market exposure and, for example, to extend the mirroring of partially mirrored investment positions to other broker accounts.

In step S144, based on the current financial market analysis data 18, the order generator 13 checks the current portfolio structure for opportunities of increasing existing investment positions or establishing new investment positions for an underlying investment selection of the portfolio. The order generator 13 does not generate increase orders, if a loss portion of capital resources associated with the portfolio exceeds a defined loss limit, e.g. if a portion of more than 8% of the capital resources is lost, according to the current market situation; and/or if the number of investment positions in a loss position exceeds a loss position limit. Moreover, the order generator 13 suppresses orders for increasing an existing investment position in a portfolio, as long as there are decrease orders pending for investment positions related to the same underlying investment selection. Otherwise, the order generator 13 uses the money management function to maximize the invested portion of the capital resources associated with the portfolio. Specifically, the order generator 13 uses the money management function to generate orders, such that, for any broker account of the specific portfolio, a maximum portion of capital resources associated with the broker account is invested, attempting to invest as close as possible to 100% of the capital resources. Furthermore, the money management function is configured to determine opportunities to free up capital resources by replacing investment positions in stocks with investment positions in options, e.g. as soon as 90% of the portfolio's capital resources are invested (because an option includes a leverage component of approximately 90%, the portfolio comprises twice as many stocks when it is thus increased to having 90% of its capital resources invested, assuming conversion of options into stocks). The order generator 13 is further configured to generate orders in adherence to the user preferences. Particularly, investment instruments related to the user's underlying investment selections are purchased through the assigned preferred broker account, within the limits of the available capital resources of the broker account. If there is no opportunity of increasing existing investment positions or establishing new investment positions, the order generator 13 continues in step S146.

In step S145, the order generator 13 generates order data for increase orders for increasing existing investment positions or establishing new investment positions based on the results of step S144.

In step S146, the order generator 13 uses the money management function to determine whether a satisfactory degree of investment level has been reached for all accounts, e.g. 99% of the capital resources of each broker account are invested, if permitted by system- and/or user-defined limits. If a satisfactory investment degree has been reached, the order generation ends in step S147; otherwise, the order generator 13 continues in step S144.

In step S147, step S14 ends and the process continues in step S15.

TABLE 2

| Identifier of | | | | |
|---|---|---|---|---|
| Investment | | | | |
| instrument | | | | |
| (stock, option, | | | | |
| futures | Order | Order | Order | Broker |
| contract) | type | quantity | price | account |
| 201-4-S | DECR defensive | −100 | 111.50 | 5 |
| 101-9-S | DECR defensive | 100 | 55.00 | 1 |
| 721-11-S | DECR defensive | −100 | 49.20 | 3 |
| 201-4-S | DECR aggressive | 100 | 45.00 | 3 |
| 201-4-S | NEW urgent | 300 | 33.00 | 2 |
| 101-11-O | INCR urgent | 100 | 98.00 | 4 |
| 201-9-S | INCR | 50050 | 106.00 | 4 |
| 201-4-S | NEW urgent | −200 | 89.33 | 1 |
| 721-11-S | NEW | 100 | 113.00 | 4 |
| . . . | . . . | . . . | . . . | . . . |
| 201-4-S | DECR aggressive | 200 | 86.00 | 4 |

In step S15, using the communication module 10, the order generator 13 communicates the orders generated in step S14 through the user interface module 11 and via telecommunications network 2 to the respective user of the communication terminal 3. For example, as illustrated in Table 2, the orders are presented to the user in a list displayed on a display of the communication terminal 3.

Preferably, orders are communicated by the system 1 subsequently to their generation, in response to a previous user request (pull mode). In an alternative embodiment, if the orders are generated automatically, in response to repeatedly (e.g. periodically) updated financial market analysis data 18, the orders are communicated proactively by the system 1 to the users who have selected a respective option, for example (push mode).

In step S16, the user interface module 11 receives from the user portfolio structure data indicating the current structure of the user's portfolio. Furthermore, together with the portfolio structure data, the user provides his preferences. In an alternative embodiment, the user interface module 11 receives order placement data identifying those orders provided to the user in step S15 that are actually placed by the user. The user may place the orders with a broker, for example via telecommunications network 2 through the computerized broker portal 5. In an embodiment, the control module 14 is configured to place an order automatically with the computerized broker portal 5, in response to order placement data received from the user.

Responsive to the reception of portfolio structure data, control module 14 continues in step S12. In step S12, the control module 14 updates the portfolio structure of the user's portfolio in the local data store for financial investment portfolios 15 based on the received portfolio structure data (or the order placement data, respectively).

Preferably, analysis module 12 is configured to execute step S2 for determining current financial market analysis data (as a parallel process) independently from step S1. Preferably, analysis module 12 is implemented on a separate server, accessed by the order generator 13 via a telecommunications network, e.g. a LAN or the Internet. Preferably, the order generator 13 retrieves the updated financial market analysis data 18 on a repeated basis more than once a day, e.g. periodically every five to fifteen minutes. Alternatively, execution of step S2 is initiated as required, for example in step S13, by the control module 14 triggering the analysis module 12.

Preferably, orders are communicated by the system 1 subsequently to their generation, in response to a previous user request (pull mode). In an alternative embodiment, if the orders are generated automatically, in response to repeatedly (e.g. periodically) updated financial market analysis data 18, the orders are communicated proactively by the system 1 to the users who have selected a respective option, for example (push mode).

The proposed system and method for managing financial investment portfolios make it possible to determine and select consistently and much faster than manually possible from any number of investment possibilities (for underlying investment selections) those that meet defined general investment principles and defined individual selection criteria, and to determine and select again from those the ones that are required, possible and most appropriate. In comparison to manual processing, time savings of at least 40 to 90 minutes are estimated for a typical trading day. In periods of volatile markets, there are often investment risks and/or opportunities of a very short duration which can be handled by the proposed system and method but could not be addressed manually.

The foregoing disclosure of the embodiments of the invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents. Specifically, in the description, the computer program code has been associated with specific software modules, one skilled in the art will understand, however, that the computer program code may be structured differently, without deviating from the scope of the invention. Furthermore, the particular order of the steps set forth in the specification should not be construed as limitations on the claims. One skilled in the art will understand that different sequences of steps are possible without deviating from the scope of the invention. Moreover, for better clarity and simplicity the written and graphical disclosure has been reduced, at least partly, to sequential processing; however, one skilled in the art will understand that many of the processing steps are ideally performed in a highly iterative manner.

What is claimed is:

1. A computerized system for managing financial investment portfolios, each portfolio including a user's multiple investment positions related to one of stocks, options and futures contracts, and associated with one or more broker accounts, the system comprising:
a user interface module configured to receive from the user one or more underlying investment selections for his portfolio;
an analysis module configured to determine current financial market analysis data for the underlying investment selections of a portfolio based on historical and current financial market data;
an order generator configured to generate, for a specific portfolio, based on the current financial market analysis data, order data relating to orders for decreasing existing investment positions, for increasing existing investment positions and/or for establishing new investment positions, the order data indicating for each order a selected one of the underlying investment selections associated with the specific portfolio, an investment instrument related to one of stocks, options and futures contracts for the selected one of the underlying investment selections, an order quantity, an order price, and a broker account; and
a communication module configured to communicate to the user the order data generated.

2. The system according to claim 1, wherein, for maintaining capital resources associated with an existing investment position related to a specific underlying investment selection in a user's portfolio, the order generator is further configured to decrease market exposure of the user's portfolio by generating order data for an order relating to an investment position mirroring at least partially the existing investment position, an existing long investment position being mirrored by a corresponding short investment position, and an existing short investment position being mirrored by a corresponding long investment position.

3. The system according to claim 2, wherein, for cases where existing investment positions related to a specific underlying investment selection are spread across different broker accounts associated with a portfolio, the order generator is further configured to generate the order for the investment position mirroring the existing investment position such that the existing investment position is mirrored at least for one of the accounts.

4. The system according to claim 1, wherein the order generator is configured to generate orders for a specific portfolio such that, for any broker account of the specific portfolio, a maximum portion of capital resources associated with the broker account is invested.

5. The system according to claim 1, wherein the user interface module is further configured to receive from a user portfolio structure data representative of the user's current portfolio structure; wherein the analysis module is further configured to determine periodically updated financial market analysis data; and wherein the order generator is further configured to generate updated order data for the user's portfolio based on the current portfolio structure and based on the updated financial market analysis data.

6. The system according to claim 1, wherein the user interface module is further configured to receive from the user initial portfolio structure data indicative of the investment positions included in an existing portfolio of the user, each investment position being related to one of stocks, options and futures contracts for underlying investment selections, and associated with one or more broker accounts; and wherein the order generator is further configured to generate the order data based on the current financial market analysis data and a current portfolio structure.

7. The system according to claim 1, wherein the order generator is further configured to suppress orders for increasing existing investment positions related to a specific underlying investment selection of a portfolio, as long as there are pending orders for decreasing existing investment positions related to the specific underlying investment selection of the portfolio.

8. The system according to claim 1, wherein the order generator is further configured to stop generating orders for increasing existing investment positions and for establishing new investment positions in cases where a loss portion of capital resources associated with the user's portfolio exceeds a defined loss limit, or where the number of underlying investment selections having a net loss exceeds a defined loss position limit.

9. The system according to claim 1, wherein the order generator is configured to decrease market exposure of the user's portfolio by generating order data, for orders relating to investment positions mirroring existing investment positions and/or for decreasing existing investment positions while realizing a loss, for cases where an invested portion of capital resources associated with the user's portfolio exceeds a defined investment limit and the current financial market analysis data is indicative of an alternative investment opportunity for the portfolio's underlying investment selections.

10. The system according to claim 1, wherein the analysis module is further configured to include in the current financial market analysis data dynamic indicators representative of an observed dynamic change of an underlying investment selection.

11. The system according to claim 1, wherein the user interface module, the analysis module, and the order generator are provided on a computerized server; wherein the user interface module is further configured to receive from the user the underlying investment selections via a telecommunications network; and wherein the order generator is further configured to provide to the user the order data via the telecommunications network.

12. A computer-implemented method of managing financial investment portfolios, each portfolio including a user's multiple investment positions related to one of stocks, options and futures contracts, and associated with one or more broker accounts, the method comprising:
receiving from the user one or more underlying investment selections for his portfolio;
determining current financial market analysis data for the underlying investment selections of a portfolio based on historical and current financial market data;
generating, for a specific portfolio, based on the current financial market analysis data, order data relating to orders for decreasing existing investment positions, for increasing existing investment positions and/or for establishing new investment positions, the order data indicating for each order a selected one of the underlying investment selections associated with the specific portfolio, an investment instrument related to one of stocks, options and futures contracts for the selected one of the underlying investment selections, an order quantity, an order price, and a broker account; and
communicating to the user the order data generated.

13. The method according to claim 12, wherein, for maintaining capital resources associated with an existing investment position related to a specific underlying investment selection in a user's portfolio, the method further comprises decreasing market exposure of the user's portfolio by generating order data for an order relating to an investment position mirroring at least partially the existing investment position, an existing long investment position being mirrored by a corresponding short investment position, and an existing short investment position being mirrored by a corresponding long investment position.

14. The method according to claim 13, wherein, for cases where existing investment positions related to a specific underlying investment selection are spread across different broker accounts associated with a portfolio, the method further comprises generating the order for the investment position mirroring the existing investment position such that the existing investment position is mirrored at least for one of the accounts.

15. The method according to claim 12, wherein orders for a specific portfolio are generated such that, for any broker account of the specific portfolio, a maximum portion of capital resources associated with the broker account is invested.

16. The method according to claim 12, wherein the method further comprises receiving from the user portfolio structure data representative of the user's current portfolio structure; determining periodically updated financial market analysis data; and generating updated order data for the user's portfolio based on the current portfolio structure and based on the updated financial market analysis data.

17. The method according to claim 12, wherein the method further comprises receiving from the user initial portfolio structure data indicative of the investment positions included in an existing portfolio of the user, each investment position being related to one of stocks, options and futures contracts for underlying investment selections, and associated with one or more broker accounts; and generating the order data based on the current financial market analysis data and a current portfolio structure.

18. The method according to claim 12, wherein method further comprises suppressing orders for increasing existing investment positions related to a specific underlying investment selection of a portfolio, as long as there are pending orders for decreasing existing investment positions related to the specific underlying investment selection of the portfolio.

19. The method according to claim 12, wherein the method further comprises stopping generation of orders for increasing existing investment positions and for establishing new investment positions, in cases where a loss portion of capital resources associated with the user's portfolio exceeds a defined loss limit, or where the number of underlying investment selections having a net loss exceeds a defined loss position limit.

20. The method according to claim 12, wherein market exposure of the user's portfolio is decreased by generating order data, for orders relating to investment positions mirroring existing investment positions and/or for decreasing existing investment positions while realizing a loss, for cases where an invested portion of capital resources associated with the user's portfolio exceeds a defined investment limit and the current financial market analysis data is indicative of an alternative investment opportunity for the portfolio's underlying investment selections.

21. The method according to claim 12, wherein the method further comprises including in the current financial market analysis data dynamic indicators representative of an observed dynamic change of an underlying investment selection.

22. The method according to claim 12, wherein the underlying investment selections are received from the user via a telecommunications network; and wherein the order data is provided to the user via the telecommunications network.

23. A computerized system for generating orders for investment positions of a financial investment portfolio, each investment position relating to one of stocks, options and futures contracts, and being associated with one or more broker accounts, the system comprising:
a user interface module configured to receive from the user one or more underlying investment selections for the portfolio;
an analysis module configured to determine current financial market analysis data for the underlying investment selections based on historical and current financial market data; and
an order generator configured to generate for the portfolio, based on the current financial market analysis data, order data relating to orders for decreasing existing investment positions, for increasing existing investment positions and/or for establishing new investment positions, the order data indicating for each order a selected one of the underlying investment selections, an investment instrument related to one of stocks, options and futures contracts for the selected one of the underlying investment selections, an order quantity, an order price, and a broker account.

24. A computer-Implemented method of generating orders for investment positions of a financial investment portfolio, each investment position relating to one of stocks, options and futures contracts, and being associated with one or more broker accounts, the method comprising:
receiving from the user one or more underlying investment selections for the portfolio;
determining current financial market analysis data for the underlying investment selections based on historical and current financial market data; and
generating for the portfolio, based on the current financial market analysis data, order data relating to orders for decreasing existing investment positions, for increasing existing investment positions and/or for establishing new investment positions, the order data indicating for each order a selected one of the underlying investment selections, an investment instrument related to one of stocks, options and futures contracts for the selected one of the underlying investment selections, an order quantity, an order price, and a broker account.

25. Computer program product comprising computer program code means for controlling one or more processors of a computerized server, such that the server
receives from a user one or more underlying investment selections for a financial investment portfolio;
determines current financial market analysis data for the underlying investment selections of the portfolio based on historical and current financial market data; and
generates for the portfolio, based on the current financial market analysis data, order data relating to orders for decreasing existing investment positions, for increasing existing investment positions and/or for establishing new investment positions, the order data indicating for each order a selected one of the underlying investment selections associated with the portfolio, an investment instrument related to one of stocks, options and futures contracts for the selected one of the underlying investment selections, an order quantity, an order price, and a broker account.

26. A computerized system for managing financial investment portfolios, comprising:
a user interface module configured to receive from a user portfolio structure data related to his financial investment portfolio, the portfolio structure data indicating financial investment positions included in the portfolio, each investment position being related to one of stocks, options and futures contracts for underlying investment selections, and associated with one or more broker accounts;
an analysis module configured to determine current financial market analysis data for the underlying investment selections based on historical and current financial market data; and
an order generator configured to generate for the portfolio, based on the current financial market analysis data and the portfolio structure data, order data relating to orders for decreasing existing investment positions, for increasing existing investment positions and/or for establishing new investment positions, the order data indicating for each order a selected one of the underlying investment selections, an investment instrument related to one of stocks, options and futures contracts for the selected one of the underlying investment selections, an order quantity, an order price, and a broker account.

27. A computer-implemented method of managing financial investment portfolios, the method comprising:
receiving from a user portfolio structure data related to his financial investment portfolio, the portfolio structure data indicating financial investment positions included in the portfolio, each investment position being related to one of stocks, options and futures contracts for underlying investment selections, and associated with one or more broker accounts;
determining current financial market analysis data for the underlying investment selections based on historical and current financial market data; and
generating for the portfolio, based on the current financial market analysis data and the portfolio structure data, order data relating to orders for decreasing existing investment positions, for increasing existing investment positions and/or for establishing new investment positions, the order data indicating for each order a selected one of the underlying investment selections, an investment instrument related to one of stocks, options and futures contracts for the selected one of the underlying investment selections, an order quantity, an order price, and a broker account.

28. Computer program product comprising computer program code means for controlling one or more processors of a computerized server, such that the server
receives from a user portfolio structure data related to his financial investment portfolio, the portfolio structure data indicating financial investment positions included in the portfolio, each investment position being related to one of stocks, options and futures contracts for underlying investment selections, and associated with one or more broker accounts;
determines current financial market analysis data for the underlying investment selections of the portfolio based on historical and current financial market data; and
generates for the portfolio, based on the current financial market analysis data and the portfolio structure data, order data relating to orders for decreasing existing investment positions, for increasing existing investment positions and/or for establishing new investment positions, the order data indicating for each order a selected one of the underlying investment selections associated with the portfolio, an investment instrument related to one of stocks, options and futures contracts for the selected one of the underlying investment selections, an order quantity, an order price, and a broker account.
